(19) United States
(12) Patent Application Publication
(10) Pub. No.: US 2025/0365535 A1
(43) Pub. Date: Nov. 27, 2025

(54) Audio Waveguide Accessory for Wearable Devices

(71) Applicant: Apple Inc., Cupertino, CA (US)

(72) Inventors: Jarrett B. Lagler, San Francisco, CA (US); Esge B. Andersen, Campbell, CA (US); David M. Tremblay, Boulder, CO (US); Michael C. Friedman, Nederland, CO (US); Scott P. Porter, San Jose, CA (US)

(21) Appl. No.: 19/098,698

(22) Filed: Apr. 2, 2025

Related U.S. Application Data
(60) Provisional application No. 63/650,340, filed on May 21, 2024.

(51) Int. Cl. H04R 1/34; H04R 1/08; H04R 1/10; H04R 3/04

(52) U.S. Cl. CPC H04R 1/345; H04R 1/08; H04R 1/1008; H04R 1/1041; H04R 1/1058; H04R 1/1083; H04R 3/04; H04R 2460/01

(57) ABSTRACT

An extra-aural waveguide assembly comprising: an attachment portion configured to attach to an extra-aural audio unit of a wearable device; a waveguide portion configured to extend from the attachment portion and guide a sound wave emitted by the extra-aural audio unit to an ear of a user; and a sensor operable to detect a coupling of the attachment portion to the extra-aural audio unit.

### CROSS-REFERENCE TO RELATED APPLICATION

This application is a non-provisional application of co-pending U.S. Provisional Patent Application No. 63/650,340, filed May 21, 2024, and incorporated herein by reference.

### FIELD

An aspect of the disclosure is directed to an audio accessory for a wearable device, more specifically an audio waveguide accessory for a mixed reality headset. Other aspects are also described and claimed.

### BACKGROUND

Extra-aural speaker units or pods associated with a wearable device have inherent performance tradeoffs compared to headphones. For example, in the case of a head mounted wearable device such as a mixed, virtual or augmented reality head mounted device, the speaker unit may be mounted on a portion of the device that is near the ear. Thus, while the user can hear the sound output by the speaker unit near their ear, the speaker efficiency, loudness and/or sound quality may be lower or less immersive than if the sound was output directly into the ear, such as by a headphone on or in the ear.

### SUMMARY

An aspect of the disclosure is directed to an acoustic or audio accessory that guides audio or sound emitted from a wearable device into a user's ear without requiring a headphone. Representatively, the wearable device may be a head-mounted or worn mixed reality unit that combines both augmented and virtual realities. In this aspect, the wearable device may include, among other aspects, a display that is viewed by the user and an extra-aural speaker unit or pod that emits audio or sound to the ambient environment that corresponds to what is being viewed to enhance the user experience. The speaker unit or pod may, in some aspects, be coupled to a portion of the wearable near enough to the user's ear so that the emitted audio or sound can be heard by the ear. To improve the quality and/or loudness of the audio or sound heard by the user's ear, the acoustic or audio accessory may be configured to guide or direct the audio directly to the ear. For example, the use of the acoustic or audio accessory enables an optional performance mode that improves the acoustic loudness (e.g., an additional 10-20 dB relative to the baseline performance), low frequency bandwidth (e.g., an additional 1 to 2 octaves from the baseline performance), and/or improved power consumption. Moreover, compared to headphones, this approach has the benefit of being lower in cost, does not require a wireless audio connection, and/or maintains other advantages of non-occluding extra-aural speaker units or pods such as physical comfort. In addition, guiding the audio or sound to the ear using the audio accessory may provide a more private experience for the user. For example, the acoustic or audio accessory may be a passive waveguide or similarly configured structure that is coupled, mounted or otherwise attached to the speaker unit or pod and extends over the user's ear to physically direct the audio or sound emitted by the speaker out the other end of the accessory directly to the ear. In some aspects, the accessory may include two discrete waveguides for stereo and/or Spatial Audio playback (e.g., left and right ears). Alternatively, the passive audio accessory may be coupled or otherwise attached to a strap or other structure associated with the wearable device and aligned with the speaker unit or pod. In some aspects, the end of the accessory where the sound is output may hover over the ear, while in other aspects there may be a cushion or some other aspect that rests on or otherwise covers the ear. In some aspects, the presence of the audio accessory may be detected by the wearable device and the audio output may be tuned for an enhanced user experience when the accessory is attached. For example, the audio accessory may be coupled or uncoupled to the wearable device manually by the user as desired, and a sensor associated with the accessory or wearable device may detect whether or not the two components are attached to one another. In other aspects, the audio accessory may further include a microphone near the user's ear that can pick up sound near the ear that may be used for adaptive equalization of sound, noise cancellation, or other adaptive algorithms that may enhance the listening experience of the user.

In some aspects, the disclosure is directed to an extra-aural waveguide assembly comprising: an attachment portion configured to attach to an extra-aural audio unit of a wearable device; a waveguide portion configured to extend from the attachment portion and guide a sound wave emitted by the extra-aural audio unit to an ear of a user; and a sensor operable to detect a coupling of the attachment portion to the extra-aural audio unit. In some aspects, the attachment portion is configured to self-align with the extra-aural audio unit. In other aspects, the attachment portion comprises an interior surface having a protrusion that attaches the attachment portion to the extra-aural audio unit. In still further aspects, the attachment portion includes a magnet assembly that aligns and attaches the attachment portion to the extra-aural audio unit. In some aspects, the waveguide portion defines a channel that guides the sound wave emitted by the extra-aural audio unit from an output port of the extra-aural audio unit to a sound output opening at an end of the waveguide portion. In other aspects, the waveguide portion is configured to hover over a substantial portion of the ear. In still further aspects, a cushion is coupled to the waveguide portion and configured to rest on the ear. In some aspects, the sensor comprises a hall-effect sensor coupled to the attachment portion or the extra-aural audio unit that detects the coupling of the attachment portion to the extra-aural audio unit. In other aspects, the sensor may be a capacitive sensor, a proximity sensor or other electrical/mechanical sensor that can detect the attachment of one portion to another portion. In still further aspects, a digital signal processing unit for tuning of the sound wave when coupling of the attachment portion is detected is further provided. In some aspects, the sensor may be a first sensor, and the assembly may further include a second sensor coupled to the waveguide portion that is configured to detect when the waveguide portion is positioned over the ear. In some aspects, a microphone may be coupled to the waveguide portion and configured to detect an acoustic characteristic near the ear for tuning of the sound wave emitted by the extra-aural audio unit.

In other aspects, an extra-aural waveguide assembly may include a first portion configured to attach to an extra-aural audio unit of a wearable device, a second portion configured to extend from the attachment portion to guide a sound wave emitted by the extra-aural audio unit to an ear of a user and a sensor operable to detect a condition of the extra-aural waveguide assembly; and one or more processors communicatively coupled to the extra-aural waveguide assembly and operable to tune the sound wave based on the detected condition of the extra-aural waveguide assembly. The first portion may be configured to self-align with the extra-aural audio unit. The first portion may define a channel that guides the sound wave output by the extra-aural audio unit from an output port of the extra-aural audio unit to a sound output opening at an end of the second portion. The sensor may include a hall-effect sensor coupled to the first portion or the extra-aural audio unit and the condition detected is a coupling of the attachment portion to the extra-aural audio unit. In some aspects, the one or more processors may include a digital signal processor for tuning of the sound wave when coupling of the attachment portion is detected. The sensor may include a proximity sensor coupled to the second portion and the detected condition is a positioning of the second portion over the ear. In other aspects, the one or more processors may include a processor configured to activate an adaptive equalization algorithm function for tuning the sound wave to the ear when positioning of the second portion over the ear is detected. The system may further include a microphone coupled to the second portion that is configured to detect an ambient noise near the ear. In other aspects, the one or more processors include a processor configured to activate a noise cancellation function when ambient noise near the ear is detected.

The above summary does not include an exhaustive list of all aspects of the present disclosure. It is contemplated that the disclosure includes all systems and methods that can be practiced from all suitable combinations of the various aspects summarized above, as well as those disclosed in the Detailed Description below and particularly pointed out in the claims filed with the application. Such combinations have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect in this disclosure are not necessarily to the same aspect, and they mean at least one.

FIG. 1 illustrates a side perspective view of a user wearing a wearable device including an audio accessory.

FIG. 2 illustrates a cross-sectional side view of the audio accessory of FIG. 1 along line 2-2′.

FIG. 3 illustrates a cross-sectional side view of the audio accessory of FIG. 1 along line 2-2′.

FIG. 4 illustrates a cross-sectional side view of the audio accessory of FIG. 1 along line 2-2′.

FIG. 5 illustrates a block diagram of one representative process flow for using the audio accessory.

FIG. 6 illustrates a block diagram of an example system of a wearable device including the audio accessory.

### DETAILED DESCRIPTION

In this section we shall explain several preferred aspects of this disclosure with reference to the appended drawings. Whenever the shapes, relative positions and other aspects of the parts described are not clearly defined, the scope of the disclosure is not limited only to the parts shown, which are meant merely for the purpose of illustration. Also, while numerous details are set forth, it is understood that some aspects of the disclosure may be practiced without these details. In other instances, well-known structures and techniques have not been shown in detail so as not to obscure the understanding of this description.

The terminology used herein is for the purpose of describing particular aspects only and is not intended to be limiting of the disclosure. Spatially relative terms, such as “beneath”, “below”, “lower”, “above”, “upper”, and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (e.g., rotated 90 degrees or at other orientations) and the spatially relative descriptors used herein interpreted accordingly.

As used herein, the singular forms “a”, “an”, and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

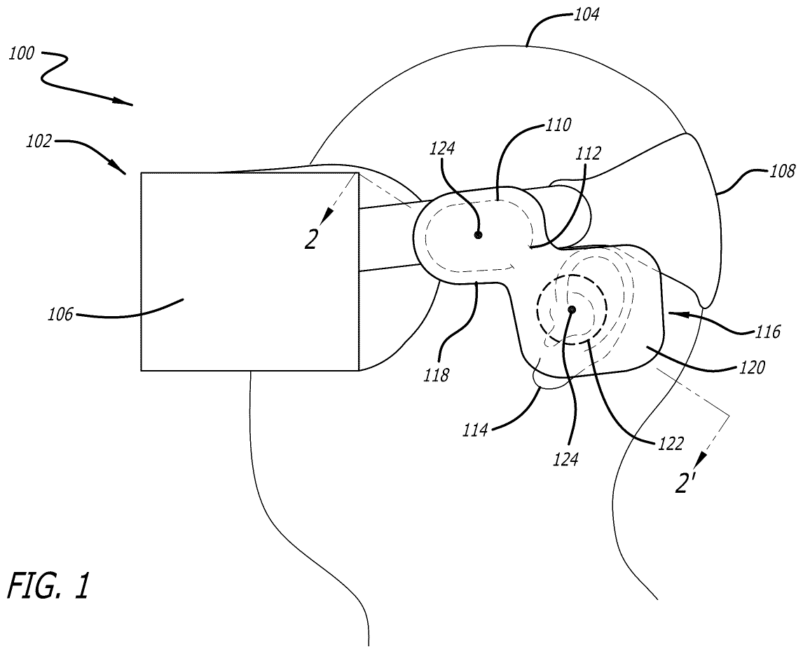

FIG. 1 illustrates a side perspective view of a user wearing a wearable device including an acoustic or audio accessory. Representatively, as can be seen from this view, wearable device 102 is mounted or worn on the user's head 104. For example, wearable device 102 may, in some aspects, be a mixed reality unit that includes a display 106 positioned over the user's eyes. Display 106 may include, or be enclosed within, a housing configured to rest on the user's face and contain various components for displaying stereoscopic images to the user, such as screens, lenses, sensors and/or audio components. Device 102 further includes a strap 108 that connects to the display 106 and encircles the head 104 to hold or mount display 106 in position over the user's eyes. An audio or acoustic pod or unit 110 including an output port 112 may further be mounted to device 102 to output or emit a sound that enhances the visual effects displayed by display 106 to the user's ear 114. For example, in some aspects, audio or acoustic pod or unit 110 may be an extra-aural speaker pod that is mounted to a portion of strap 108 near the user's ear 114. The speaker pod may be configured to output or otherwise emit a sound from a speaker port 112 near the user's ear 114 that corresponds to, for example, images or realities being output by display 106.

To further enhance the experience, acoustic or audio assembly or accessory 116 may be connected, attached or mounted to audio pod 110, or another suitable portion of the wearable device near the user's ear 114. Audio accessory 116 may be configured to direct or guide the sound waves emitted from speaker port 112 directly to the user's ear 114. In some aspects, audio accessory 116 may be considered or referred to herein as a passive audio accessory or a passive audio waveguide because it has a shape, size and/or structure selected to passively guide sound waves directly to ear 114. Representatively, acoustic or audio accessory 116 may include a housing having an acoustically optimized construction that may include soft textiles, variable absorption and/or rigid boundaries. For example, in some aspects, the accessory 116 may be constructed of a housing having a first portion 118 that attaches to audio pod 110 and a second portion 120 that extends from pod 110 over the user's ear 114 to guide the sound emitted by pod 110 to the ear 114. Second portion 120 may further include a sound output port or opening 122 facing ear 114 so that the sound exits second portion 120 directly to ear 114. First portion 118 may have any shape and size suitable for being positioned over, and attached to, audio pod 110 so that sound emitted from port 112 of audio pod 110 enters first portion 118. For example, in some aspects, first portion 118 may have an oval or racetrack shape that matches the shape of audio pod 110 such that first portion 118 is mounted over and encloses the entire audio pod 110. In other aspects, first portion 118 may be configured to be mounted to and enclose less than the entire audio pod 110, for example, only the sound output port 112. In still further aspects, first portion 118 may be configured to be mounted to and/or attached to another portion of the wearable device 102 such as a portion of strap 108 or display 106 near ear 114. Second portion 120 may have any size and shape suitable for physically or passively guiding the sound waves from first portion 118 to the ear 114. Representatively, in some aspects, second portion 120 may have a shape that somewhat matches that of ear 114, for example, a square or rectangular shape with rounded corners as shown, which covers some or all of ear 114 and more specifically the ear pinna. In other aspects, second portion 120 may have a more elongated shape, such as a horn shape that is narrower at an end attached to first portion 118 and widens toward the ear so that the end having opening 122 covers some or all of ear 114, and opening 122 is generally aligned with the ear canal. In addition, in some aspects, one or more sensors 124 may further be coupled to audio accessory 116 to detect a characteristic or condition associated with audio accessory 116 and/or ear 114. Representatively, sensors 124 could include a sensor that detects an attachment of audio accessory 116 to audio pod 110, a positioning of audio accessory 116 on or near ear 114 and/or an ambient noise or other acoustic characteristic near ear 114. Based on the condition or characteristic detected by sensors 124, one or more processors associated with the system or assembly may activate a digital signal processing function to tune the acoustic output of audio pod 110 and/or adaptive algorithm function such as active noise cancellation or adaptive equalization to tune or adjust the acoustic output to the user's profile.

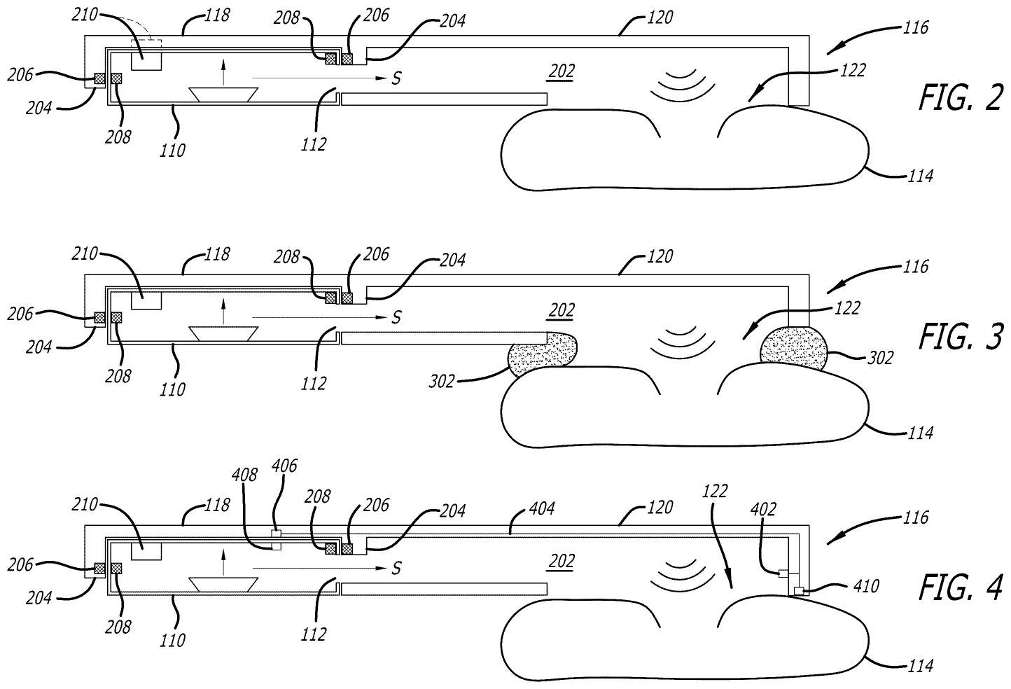

Referring now to FIG. 2, FIG. 2 illustrates a cross-sectional view of the audio or acoustic accessory of FIG. 1 along line 2-2′. From this view, the various aspects of audio or acoustic accessory 116 can be seen in more detail. Representatively, from this view, it can be seen that acoustic accessory 116 includes first portion 118 attached to audio pod 110 and second portion 120 defining a channel 202 extending over the user's ear 114 to physically guide sound (S) emitted from audio pod 110 to the ear 114. As can further be seen from this view, first portion 118 may have a shape and size configured to self-align and attach to audio pod 110. Representatively, first portion 118 may have an interior surface facing audio pod 110 that includes protruding portions 204 that are of a size and shape suitable to be positioned around a perimeter of audio pod 110. For example, in some aspects, protruding portions 204 may be sides of a protruding ring-shaped region that matches a shape (e.g., a perimeter shape) of audio pod 110 and surrounds audio pod 110. Protruding portions 204 may therefore align first portion 118 to audio pod 110 in a manner that, in turn, aligns second portion 120 over ear 114. For example, protruding portions 204 may be configured to position or align first portion 118 around audio pod 110 in only one orientation so that once they are coupled together, second portion 120 is always properly aligned over ear 114 and any misalignment is prevented.

In some aspects, first portion 118 may further include attachment mechanisms 206 to secure first portion 118 to audio pod 110. Representatively, in some aspects, attachment mechanisms 206 may be coupled to each of the protruding portions 204, and attach to complimentary attachment mechanisms 208 coupled to audio pod 110. For example, in some aspects, attachment mechanisms 206, 208 may be magnetic attachment mechanisms that help to self-align first portion 118 to pod 110 and once aligned, the magnetic forces attach them together. In other aspects, attachment mechanisms 206, 208 may be complimentary mechanical fasteners, clips, clamps or the like which mechanically align and attach first portion 118 to pod 110.

In still further aspects, first portion 118 may include a sensor 210 that detects or recognizes that acoustic or audio accessory 116 is connected to audio pod 110. In some aspects, when sensor 210 detects or recognizes audio accessory 116, the device may further tune the acoustic performance of audio pod 110 accordingly. For example, when audio accessory 116 is on audio pod 110, the sound is guided to ear 114 as previously discussed, which may result in, for example, a 20 or more decibel boost and/or extra audio bandwidth reaching ear 114. The system may therefore tune audio pod 110 to account for this and achieve the desired acoustic experience. For example, the system may include a digital signal processing (DSP) feature that changes audio tunings to optimize the acoustic experience when audio accessory 116 is detected. In some aspects, sensor 210 may be a hall-effect sensor, proximity sensor or other electrical/mechanical sensor that is coupled to audio pod 110 and can detect the presence of first portion 118 attached to pod 110. It is further contemplated that sensor 210, or a portion of sensor 210, may alternatively or also be coupled to first portion 118.

It may further be understood from this view that second portion 120 may cover some or all of the pinna of ear 114. In addition, second portion 120 may be configured to hover over ear 114 such that it does not seal to ear 114 and creates a more open experience. For example, second portion 120 may hover over ear 114 and align opening 122 with the ear canal so the sound is directed out opening 122 directly into the ear canal.

Referring now to FIG. 3, FIG. 3 illustrates a cross-sectional view of an alternative configuration of the audio or acoustic accessory of FIG. 1 along line 2-2′. Representatively, FIG. 3 illustrates an audio or acoustic accessory 116 including all the same components as the audio or acoustic accessory previously discussed in reference to FIG. 2. Thus, the previous description in reference to FIG. 2 also applies to audio or acoustic accessory 116 of FIG. 3. The audio or acoustic accessory 116 of FIG. 3, however, further includes a pad or cushion 302 that rests on ear 114 and couples accessory 116 to the ear for a more closed or sealed listening experience. Representatively, pad or cushion 302 may be attached to the side of second portion 120 facing ear 114 and surround opening 122. For example, pad or cushion 302 may be a circular or elongated foam pad or cushion that is attached to second portion 120. In this aspect, when second portion 120 is positioned over ear 114, cushion 302 rests on the pinna of ear 114. In other aspects, cushion 302 may be larger than ear 114 such that it is configured to encircle the pinna of ear 114. As a result, more of the sound emitted by speaker pod 110 may be guided into ear 114 and cushion may also block out some of the ambient noise or sound to prevent it from interfering with the sound emitted by pod 110.

Referring now to FIG. 4, FIG. 4 illustrates a cross-sectional view of an alternative configuration of the audio or acoustic accessory of FIG. 1 along line 2-2′. Representatively, FIG. 4 illustrates an audio or acoustic accessory 116 including all the same components as the audio or acoustic accessory previously discussed in reference to FIG. 2. Thus, the previous description in reference to FIG. 2 also applies to audio or acoustic accessory 116 of FIG. 4. The audio or acoustic accessory 116 of FIG. 4, however, further includes a sensor 402 for detecting an acoustic characteristic near ear 114 and a sensor 410 for detecting whether accessory 116 is on or near ear 114. Representatively, sensor 402 may be a microphone that is attached to second portion 120 near an ear canal of ear 114. The microphone may be configured to pick up an acoustic characteristic such as ambient or other sounds near the ear and then use this information for adaptive tuning such as adjusting sound frequencies for a more consistent experience, noise cancellation, or other adaptive algorithms. For example, when ambient noise is detected by microphone 402, a processor associated with the system or assembly may activate an active noise cancellation function that causes a system speaker (not shown) to produce anti-noise that reduces the ambient noise leaking into ear 114 from the ambient environment. In some aspects, sensor 402 may be electrically coupled by wire 404 to self-aligning electrical contacts 406, 408 between speaker pod 110 and accessory 116 that may be used for power and/data transmission to sensor 402. For example, when first portion 118 attaches to speaker pod 110, contact 406 coupled to first portion 118 aligns with contact 408 coupled to speaker pod 110.

Sensor 410, on the other hand, may be a proximity or other similar type of sensor (e.g., a radio frequency identification (RFID) sensor) that is capable of detecting that accessory 116 is on or near ear 114. For example, sensor 410 may be attached to an end of second portion 120 as shown. Sensor 410 may emit an electromagnetic field or beam of electromagnetic radiation away from second portion 120 and detect changes in the field or return signal due to the second portion 120 being near or on ear 114. When sensor 410 detects second portion 120 is on or near ear 114, the system may be configured to engage in additional tuning or adaptive algorithm functions to tune or otherwise enhance the audio output to the user by speaker pod 110. For example, when sensor 410 detects that accessory 116 is on or near ear 114, a processor associated with the system or assembly may activate an adaptive equalization algorithm or function that tunes the sound output based on the user's hearing profile or shape of the user's ear to improve the acoustic experience.

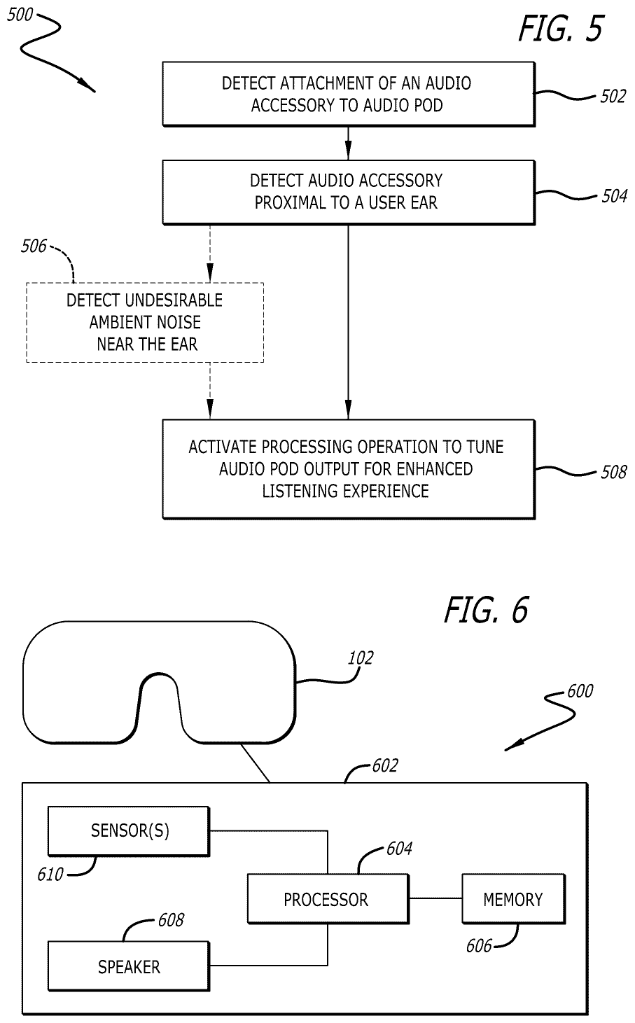

Representatively, FIG. 5 illustrates a block diagram of one representative process flow for applying adaptive algorithms when an acoustic or audio accessory is coupled to the speaker pod. Process 500 may include an initial operation 502 of detecting attachment of audio accessory to an audio pod of a wearable device. For example, the attachment may be detected by one or more of a hall-effect sensor, proximity sensor or other electrical/mechanical sensor 210 that is coupled to audio pod 110 to detect attachment of audio accessory 116 to pod 110, as previously discussed in reference to FIG. 2. Once the attachment of audio accessory to audio pod is detected, the process continues to operation 504 for detecting whether the audio accessory is near or proximal to the user's ear. For example, a proximity sensor 410 as previously discussed in reference to FIG. 4 may be coupled to accessory 116 to detect whether the accessory is near the ear. In addition, process 500 may further include an optional operation 506 of detecting whether any undesirable ambient noise is present near the ear. For example, a sensor such as a microphone 402 previously discussed in reference to FIG. 4 may pick up any undesirable background or ambient noises near ear 114. Process 500 may then continue to operation 508 in which the system activates a digital system processing operation to tune the audio pod output based on the previously detected conditions to achieve an enhanced listening experience. For example, when the audio accessory is detected attached to the speaker pod and/or near the user's ear, the system may activate a digital system processing feature that changes the audio tunings and optimizes the acoustic output to the ear. In still further aspects, the detection of ambient noises or other background noises near the ear may be used for adaptive tuning such as adjusting sound frequencies for a more consistent experience, noise cancellation, or other adaptive algorithms.

FIG. 6 illustrates a block diagram of an example system of a wearable device including the audio accessory. System 600 may include a wearable device 102 (e.g., a mixed reality wearable device) as previously discussed in reference to FIG. 1. Wearable device 102 may further include a computing or electronic device 602, or otherwise be communicatively coupled to a computing or electronic device 602, that is operable to perform the various functions and/or processing operations described herein. For example, device 602 may include a processor 604 connected to a memory 606 that stores a software application or adaptive algorithm for tuning an acoustic output as previously discussed. For example, if one or more of sensors 610 detect that the audio accessory (e.g., accessory 116) is attached to the speaker and is on or near the ear of the user, processor 604 may initiate a digital signal processing function to tune the audio signal emitted by speaker 608 to achieve the desired acoustic output based on this information. In still further aspects where sensor 604 is a microphone that detects background or ambient noises near the user's ear as previously discussed, processor 604 may initiate an adaptive algorithm that adjusts sound frequencies for a more consistent experience, noise cancellation, or other adaptive algorithms to improve the users audio experience.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. For example, although an exemplary mixed reality wearable device is described herein, it is contemplated that the wearable device may be any number of devices worn on the head of a user and having extra-aural speakers, including but not limited to, an augmented or virtual reality headset, spectacles, glasses, goggles, helmets, medical devices or the like. The description is thus to be regarded as illustrative instead of limiting. In addition, to aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What is claimed is:

1. An extra-aural waveguide assembly comprising:
an attachment portion configured to attach to an extra-aural audio unit of a wearable device;
a waveguide portion configured to extend from the attachment portion and guide a sound wave emitted by the extra-aural audio unit to an ear of a user; and
a sensor operable to detect a coupling of the attachment portion to the extra-aural audio unit.

2. The assembly of claim 1 wherein the attachment portion is configured to self-align with the extra-aural audio unit.

3. The assembly of claim 1 wherein the attachment portion comprises an interior surface having a protrusion that attaches the attachment portion to the extra-aural audio unit.

4. The assembly of claim 1 wherein the attachment portion comprises a magnet assembly that aligns and attaches the attachment portion to the extra-aural audio unit.

5. The assembly of claim 1 wherein the waveguide portion defines a channel that guides the sound wave emitted by the extra-aural audio unit from an output port of the extra-aural audio unit to a sound output opening at an end of the waveguide portion.

6. The assembly of claim 1 wherein the waveguide portion is configured to hover over a substantial portion of the ear.

7. The assembly of claim 1 further comprising a cushion coupled to the waveguide portion and configured to rest on the ear.

8. The assembly of claim 1 wherein the sensor comprises a hall-effect sensor coupled to the attachment portion or the extra-aural audio unit that detects the coupling of the attachment portion to the extra-aural audio unit.

9. The assembly of claim 8 further comprising a digital signal processing unit for tuning of the sound wave when coupling of the attachment portion is detected.

10. The assembly of claim 1 wherein the sensor comprises a first sensor, and further comprising a second sensor coupled to the waveguide portion that is configured to detect when the waveguide portion is positioned over the ear.

11. The assembly of claim 1 further comprising a microphone coupled to the waveguide portion and configured to detect an acoustic characteristic near the ear for tuning of the sound wave emitted by the extra-aural audio unit.

12. An extra-aural waveguide system comprising:
an extra-aural waveguide assembly comprising a first portion configured to attach to an extra-aural audio unit of a wearable device, a second portion configured to extend from the attachment portion to guide a sound wave emitted by the extra-aural audio unit to an ear of a user and a sensor operable to detect a condition of the extra-aural waveguide assembly; and
one or more processors communicatively coupled to the extra-aural waveguide assembly and operable to tune the sound wave based on the detected condition of the extra-aural waveguide assembly.

13. The system of claim 12 wherein the first portion is configured to self-align with the extra-aural audio unit.

14. The system of claim 12 wherein the first portion defines a channel that guides the sound wave emitted by the extra-aural audio unit from an output port of the extra-aural audio unit to a sound output opening at an end of the second portion.

15. The system of claim 12 wherein the sensor comprises a hall-effect sensor coupled to the first portion or the extra-aural audio unit and the condition detected is a coupling of the attachment portion to the extra-aural audio unit.

16. The system of claim 15 wherein the one or more processors comprise a digital signal processor for tuning of the sound wave when coupling of the attachment portion is detected.

17. The system of claim 12 wherein the sensor comprises a proximity sensor coupled to the second portion and the detected condition is a positioning of the second portion over the ear.

18. The system of claim 17 wherein the one or more processors comprises a processor configured to activate an adaptive equalization algorithm function for tuning the sound wave to the ear when positioning of the second portion over the ear is detected.

19. The system of claim 12 further comprising a microphone coupled to the second portion that is configured to detect an ambient noise near the ear.

20. The system of claim 19 wherein the one or more processors comprises a processor configured to activate a noise cancellation function when ambient noise near the ear is detected.
